(19) United States
(12) Patent Application Publication
(10) Pub. No.: US 2024/0081307 A1
(43) Pub. Date: Mar. 14, 2024

(54) CONTROL CASE AND FISHING ELECTRIC REEL COMPRISING THE SAME

(71) Applicant: GLOBERIDE, Inc., Tokyo (JP)

(72) Inventor: Keisuke MATSUNO, Tokyo (JP)

(21) Appl. No.: 18/241,037

(22) Filed: Aug. 31, 2023

(30) Foreign Application Priority Data
Sep. 9, 2022 (JP) 2022-144009

(51) Int. Cl. A01K 89/015; A01K 89/012

(52) U.S. Cl. CPC A01K 89/0192; A01K 89/012

(57) ABSTRACT

A control case for a fishing electric reel comprises: an electrical component; a case body comprising a lower case and an upper case that has one or a plurality of second through holes; a cover member having one or a plurality of first through holes; one or a plurality of switch operating parts; and a recess-projection fitting portion. The case body is arranged on an upper portion of a reel body. The cover member is mounted on an upper side of the upper case. The one or the plurality of switch operating parts are capable of being inserted into the one or the plurality of first through holes and the one or the plurality of second through holes. The recess-projection fitting portion is configured to align a positioning of the cover member and the upper case in order to ensure concentricity between the first through hole and the second through hole.

### CROSS-REFERENCE TO RELATED APPLICATION

This application claims priority under 35 U.S.C. § 119 to Japanese Patent Application No. 2022-144009 filed on Sep. 9, 2022 in the Japanese Patent Office, the entire contents of each hereby incorporated by reference.

### FIELD

The present disclosure relates to a control case and a fishing electric reel comprising the same.

### BACKGROUND

Conventionally, various fishing electric reels including a control case have been known.

As a counter case of a fishing electric reel, for example, JP 2011-200124 A discloses a counter case of an electric reel that drives a spool for winding a fishing line by a brushless motor. The spool is rotatably mounted on a reel body. The counter case of an electric reel includes a case body, a circuit board, a plurality of capacitors, a liquid crystal display part, and a reel control part. The counter case has a first mounting section and a second mounting section arranged adjacently to the first mounting section, at least a part of the case body is made of metal, and is fixed to the reel body. The circuit board is mounted on the first mounting section. The plurality of capacitors are electrically connected to the circuit board and mounted on the second mounting section. The liquid crystal display part is mounted on the circuit board and is provided for depth indication. The reel control part is mounted on the circuit board and controls the brushless motor and the liquid crystal display part.

### SUMMARY

However, in the electric reel including the counter case as in JP 2011-200124 A, a switch operating part is inserted into the inner circumference of through holes formed in an upper case and a cover member with a slight gap around the outer periphery of the switch operating part. In this configuration, if the accuracy of the concentricity between the through hole in the upper case and the through hole in the cover member is low, the switch operating part becomes difficult to return due to the influence of frictional resistance caused by deviations in concentricity after pressing operation, resulting in troubles in the switch function, which has been a problem. It is also known that this problem tends to occur particularly in the switch operating part of the fishing reel to which dirt (foreign matters, fish slime, or the like) is likely to adhere.

The present disclosure has been made in view of the above circumstances, and an object of the present disclosure is to provide a control case and an electric reel comprising the control case, which is provided with an aligning mechanism by which through holes, through which a switch operating part is inserted, formed in an upper case and a cover member, are concentrically aligned with each other. The control case is configured to avoid trouble of a switch function due to the influence of frictional resistance on the switch operating part caused by deviations in concentricity between the through hole in the upper case and the through hole in the cover member, to enable the stable and reliable switch operation, and to minimize the risk of failure. Other objects of the present disclosure will become apparent by reference to the entire present specification.

A control case for a fishing electric reel according to one embodiment of the present disclosure comprises: an electrical component; a case body comprising a lower case and an upper case that comprises one or a plurality of second through holes; a cover member having one or a plurality of first through holes; one or a plurality of switch operating parts; and a recess-projection fitting portion. The electrical component is provided for controlling an electric reel. The case body is arranged on an upper portion of a reel body and houses the electrical component. The cover member is mounted on an upper side of the upper case. The one or the plurality of switch operating parts are capable of being operated by pressing and partially exposed from the cover member or partially visible from the outside of the cover member. The one or the plurality of switch operating parts are capable of being inserted into the one or the plurality of first through holes and the one or the plurality of second through holes. The recess-projection fitting portion is configured to align a positioning of the cover member and the upper case in order to ensure concentricity between the first through hole and the second through hole.

The control case for a fishing electric reel according to one embodiment of the present disclosure further comprises a display part partially exposed from the cover member or partially visible from the outside of the cover member.

The control case for a fishing electric reel according to one embodiment of the present disclosure is formed such that one of the cover member or the upper case is provided with an annular projection, while the other of the cover member or the upper case is provided with an annular recess.

In the control case for a fishing electric reel according to one embodiment of the present disclosure, the annular projection is provided radially outside the first through hole in the cover member or the second through hole in the upper case.

In the control case for a fishing electric reel according to one embodiment of the present disclosure, the annular recess is provided radially outside the first through hole in the cover member or the second through hole in the upper case.

A fishing electric reel according to one embodiment of the present disclosure comprises a reel body and a control case. The control case comprises: an electrical component; a case body comprising a lower case and an upper case that has one or a plurality of second through holes; a cover member having one or a plurality of first through holes; one or a plurality of switch operating parts; and a recess-projection fitting portion. The electrical component is provided for controlling an electric reel. The case body is arranged on an upper portion of the reel body and houses the electrical component. The cover member is mounted on an upper side of the upper case. The one or the plurality of switch operating parts are capable of being operated by pressing and partially exposed from the cover member or partially visible from the outside of the cover member. The one or the plurality of switch operating parts are capable of being inserted into the one or the plurality of first through holes and the one or the plurality of second through holes. The recess-projection fitting portion is configured to align a positioning of the cover member and the upper case in order to ensure concentricity between the first through hole and the second through hole.

According to the above embodiments, the configuration is adopted in which the through holes, through which the switch operating part is inserted, formed in the upper case and the cover member, are concentrically aligned with each other by the recess-projection fitting portion. Therefore, it is possible to provide a control case and an electric reel comprising the control case, which is configured to avoid trouble of a switch function due to the influence of frictional resistance caused by deviations in concentricity, to enable the stable and reliable switch operation, and to minimize the risk of failure.

### BRIEF DESCRIPTION OF THE DRAWINGS

FIG. 1A is a top view of an electric reel according to one embodiment of the present disclosure;

FIG. 1B is a front view of the electric reel according to one embodiment of the present disclosure;

FIG. 2 is a view describing an internal structure of the electric reel according to one embodiment of the present disclosure;

FIG. 3 is a view describing a recess-projection fitting structure of a control case in the electric reel according to one embodiment of the present disclosure;

FIG. 4 is an enlarged view describing the recess-projection fitting structure of the control case in the electric reel according to one embodiment of the present disclosure;

FIG. 5 is a view describing a case body of the control case in the electric reel according to one embodiment of the present disclosure; and

FIG. 6 is a view describing a cover member of the control case in the electric reel according to one embodiment of the present disclosure.

### DETAILED DESCRIPTION

Hereinafter, an embodiment of a fishing electric reel according to the present disclosure will be described in detail with reference to the accompanying drawings. Components common in a plurality of drawings are assigned with the same reference signs throughout the plurality of drawings. It should be noted that the drawings are not always illustrated in a precise aspect ratio for the convenience of description.

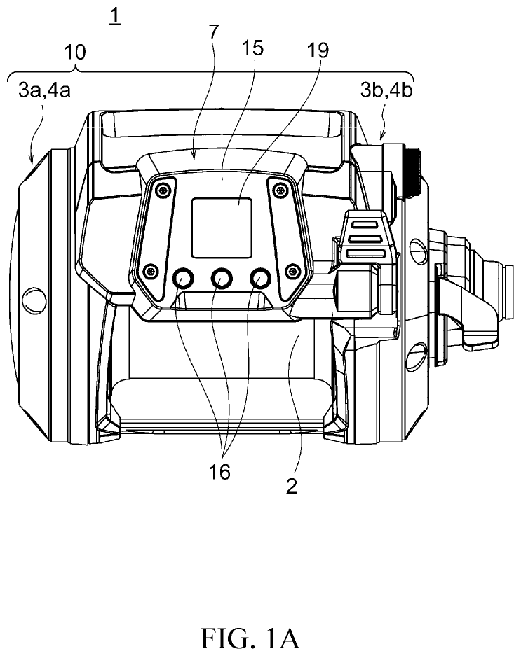

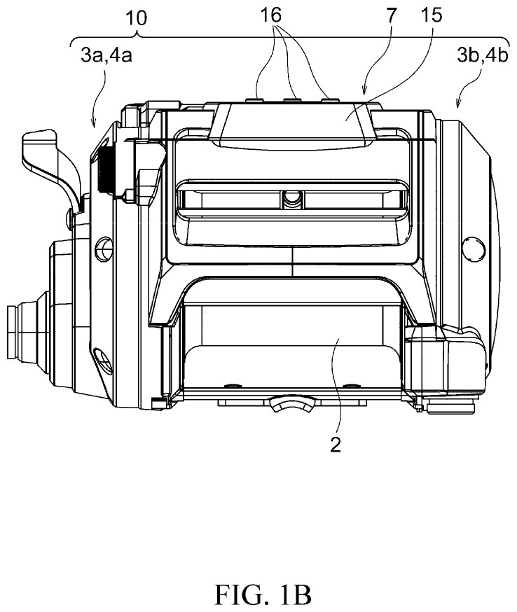

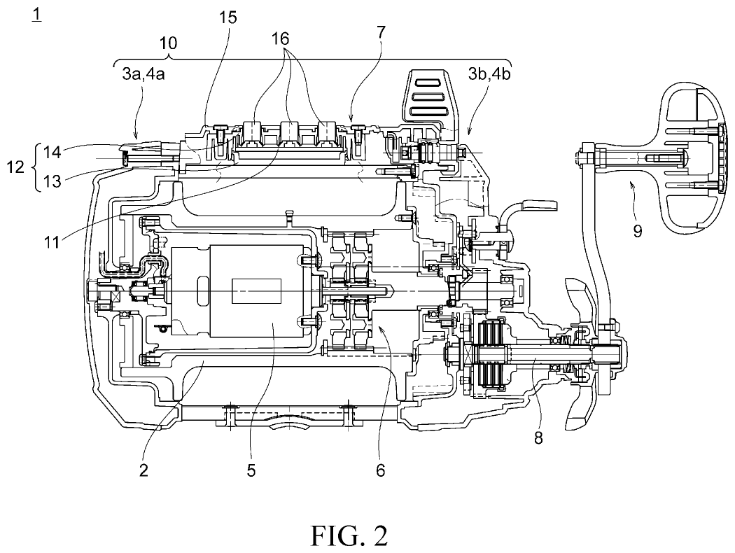

First, with reference to FIGS. 1A to 2, a basic configuration of an electric reel (fishing electric reel) 1 according to one embodiment of the present disclosure will be described. As illustrated in the drawing, the electric reel 1 is configured to wind a fishing line onto a spool 2, to switch between a state where the fishing line can be released from the spool 2 and a state where the fishing line cannot be released from the spool 2, to allow the spool 2 to slip when a tension equal to or greater than a set value is applied to the fishing line (drag function), and furthermore, to set a threshold tension and adjust a braking force for preventing backlash at the time of dropping or casting (throwing) a rig.

Also as illustrated in FIGS. 1A to 2, the electric reel 1 comprises a reel body 10 having left and right frames 3a and 3b arranged to be separated from each other on the left and right sides, and side plates 4a and 4b that cover the left and right frames 3a and 3b. The spool 2, a motor (electric motor) 5, a reduction mechanism 6, and a control case 7 are provided between the left and right frames 3a and 3b. Details of the control case 7, a cover member 15, switch operating parts 16, a display part 19, and the like will be described later. A handle shaft 8 is rotatably supported by the right frame 3b and the right side plate 4b, and an operating part (handle) 9 is attached to an end of the handle shaft 8.

The left and right frames 3a and 3b are portions forming a skeleton of the reel body 10 and are made of, for example, a metal material such as an aluminum alloy or a magnesium alloy, but are not limited thereto. The left and right frames 3a and 3b are integrated via a plurality of support pillars not illustrated. Furthermore, the motor 5 and the reduction mechanism 6 are accommodated on the front portion side of the left and right frames 3a and 3b.

The spool 2 is rotationally driven in a fishing line winding direction via the reduction mechanism 6 and the like by rotational driving of the motor 5. The reduction mechanism 6 is provided on a right frame 3b side and reduces the output of the motor 5. Further details of the basic configuration of the electric reel (fishing electric reel) 1 will be omitted.

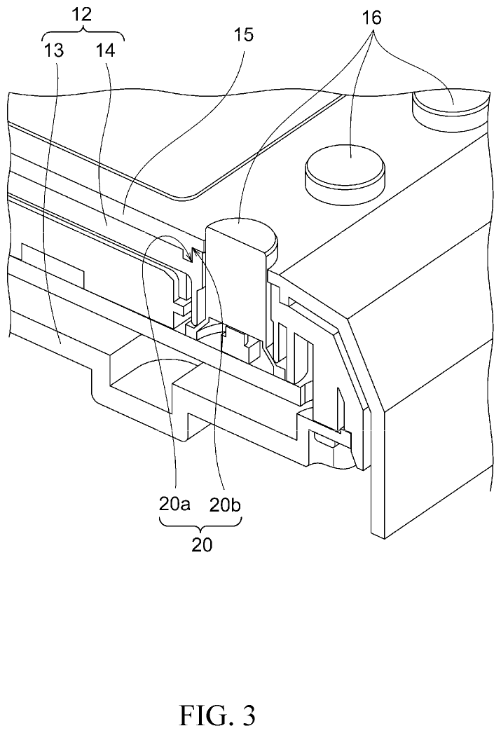

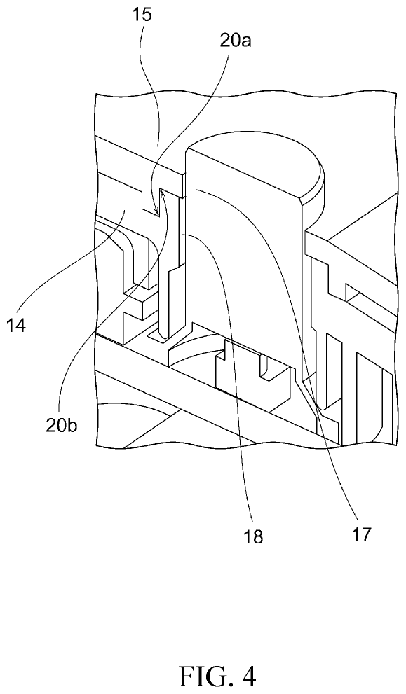

Next, the fishing electric reel 1 according to one embodiment of the present disclosure will be described with reference to FIGS. 2 to 4. The fishing electric reel 1 according to one embodiment of the present disclosure comprises the reel body 10 and the control case 7. The control case 7 comprises: an electrical component 11; a case body 12 comprising a lower case 13 and an upper case 14 that has one or a plurality of second through holes 18; the cover member 15 having one or a plurality of first through holes 17; one or a plurality of switch operating parts 16; and a recess-projection fitting portion (recess-projection engaging portion) 20. The electrical component 11 is provided for controlling the electric reel 1. The case body 12 is arranged on an upper portion of the reel body 10 and houses the electrical component 11. The cover member 15 is mounted on an upper side of the upper case 14. The one or the plurality of switch operating parts 16 are capable of being operated by pressing and partially exposed from the cover member 15 or partially visible from the outside of the cover member 15. The one or the plurality of switch operating parts 16 are capable of being inserted into the one or the plurality of first through holes 17 and the one or the plurality of second through holes 18. The recess-projection fitting portion (recess-projection engaging portion) 20 is configured to align a positioning of the cover member 15 and the upper case 14 in order to ensure concentricity between the one or the plurality of first through holes 17 and the one or the plurality of second through holes 18. In the example illustrated in FIG. 3, the recess-projection fitting portion (recess-projection engaging portion) 20 refers to a recess-projection portion 20a of the cover member 15 and a recess-projection portion 20b of the upper case 14, and is formed such that a recess of the recess-projection portion 20a of the cover member 15 is engaged with a projection of the recess-projection portion 20b of the upper case 14, and a projection of the recess-projection portion 20a of the cover member 15 is engaged with a recess of the recess-projection portion 20b of the upper case 14. However, the present disclosure is not limited to such a mode, and various modes of the recess-projection fitting portion (recess-projection engaging portion) 20 are conceivable (the same applies throughout the present specification). Here, in the present specification, the cross-sectional shape of the first through hole 17 and the second through hole 18 as viewed in a plane perpendicular to the extending direction thereof is assumed to be a circular shape, but may be other shapes, such as an elliptical shape, a polygonal shape, or the like. The cross-sectional shape is not intended to be limited to a specific shape (the same applies throughout the present specification). The same also applies to the cross-sectional shape of the switch operating part 16 as viewed in a plane perpendicular to the extending direction thereof. Furthermore, the position of the recess-projection fitting portion (recess-projection engaging portion) 20 provided in the cover member 15 and the upper case 14 can be essentially freely set, but the recess-projection fitting portion (recess-projection engaging portion) 20 is desirably provided in a circular shape concentrically with respect to the switch operating part 16. The reason for this is particularly to easily ensure concentricity between the cylindrical portion of the rubber-like switch operating part 16 and the through holes 17 and 18 around the cylindrical portion. For example, in a case where the recess-projection fitting portion 20 is set non-coaxially with the through holes 17 and 18, variations in the dimensional value from the through holes 17 and 18 to the recess-projection fitting portion 20 in a direction perpendicular to the axis of the switch operating part 16 accumulate, and thus, it is difficult to ensure concentricity compared to the case where the recess-projection fitting portion 20 is coaxially arranged with the through holes 17 and 18.

According to the electric reel 1 of one embodiment of the present disclosure, the configuration is adopted in which the through holes 17 and 18, through which the switch operating part 16 is inserted, formed in the upper case 14 and the cover member 15, can be concentrically aligned with each other by the recess-projection fitting portion 20. Therefore, it is possible to avoid trouble of a switch function due to the influence of frictional resistance caused by deviations in concentricity, to enable the stable and reliable switch operation, and to minimize the risk of failure.

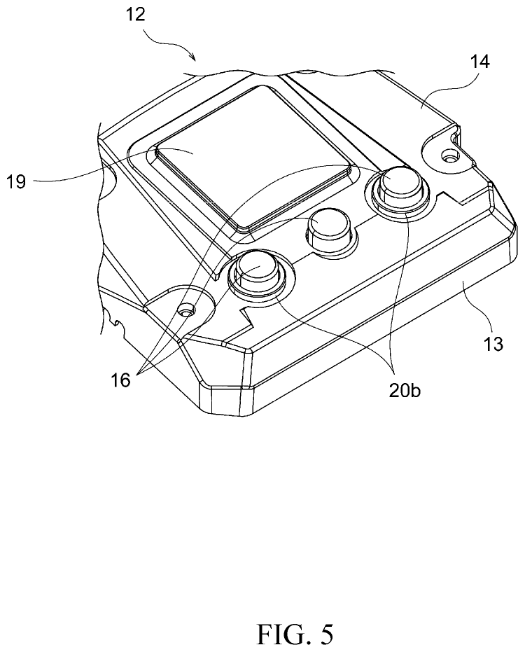

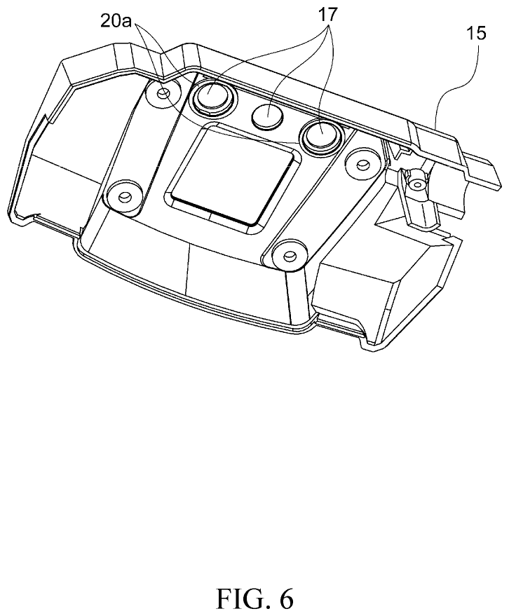

Furthermore, as illustrated in FIGS. 2 and 3 to 6, the control case 7 for the fishing electric reel 1 according to one embodiment of the present disclosure will be described. The control case 7 for the fishing electric reel 1 according to one embodiment of the present disclosure comprises: the electrical component 11; the case body 12 comprising the lower case 13 and the upper case 14 that has one or a plurality of second through holes 18; the cover member 15 having one or a plurality of first through holes 17; one or a plurality of switch operating parts 16; and the recess-projection fitting portion (recess-projection engaging portion) 20. The electrical component 11 is provided for controlling the electric reel 1. The case body 12 is arranged on the upper portion of the reel body 10 of the electric reel 1 and houses the electrical component 11. The cover member 15 is mounted on the upper side of the upper case 14. The one or the plurality of switch operating parts 16 are capable of being operated by pressing and partially exposed from the cover member 15 (the example illustrated in FIG. 3) or partially visible from the outside of the cover member 15. The one or the plurality of switch operating parts 16 are capable of being inserted into the one or the plurality of first through holes 17 and the one or the plurality of second through holes 18. The recess-projection fitting portion (recess-projection engaging portion) 20 is configured to align a positioning of the cover member 15 and the upper case 14 in order to ensure concentricity between the one or the plurality of first through holes 17 and the one or the plurality of second through holes 18. As described above, in the example illustrated in FIG. 3, the recess of the recess-projection portion 20a of the cover member 15 is engaged with the projection of the recess-projection portion 20b of the upper case 14, and the projection of the recess-projection portion 20a of the cover member 15 is engaged with the recess of the recess-projection portion 20b of the upper case 14.

According to the control case 7 for the fishing electric reel 1 of one embodiment of the present disclosure, the configuration is adopted in which the through holes 17 and 18, through which the switch operating part 16 is inserted, formed in the upper case 14 and the cover member 15, can be concentrically aligned with each other by the recess-projection fitting portion 20. Therefore, it is possible to avoid trouble of a switch function due to the influence of frictional resistance caused by deviations in concentricity, to enable the stable and reliable switch operation, and to minimize the risk of failure.

Furthermore, the control case 7 is formed in a box shape in general, and the electrical component 11 is accommodated in the control case 7. The electrical component 11 comprises, but is not necessarily limited to, a memory that stores various control programs, image data, and the like, a control substrate on which a central processing unit (CPU) that executes control processing and the like are mounted, and a circuit board on which a drive circuit that drives various drive elements such as drive motors is mounted, and the like. Furthermore, the control case 7 for the fishing electric reel 1 according to one embodiment of the present disclosure further comprises the display part 19 partially exposed from the cover member 15 or partially visible from the outside of the cover member 15. The display part 19 displays various types of information by the above-described control processing. Note that the display part 19 can include one or a plurality of display parts.

The control case 7 comprises the cover member 15 and the case body 12 as described above. However, for example, a remote controller or the like usually does not include a part corresponding to the cover member 15, but only includes a case body. From the viewpoint of waterproofness, the cover member 15 is not necessarily required also in the embodiment of the present application disclosure. On the other hand, an electric reel has a transparent case body. Therefore, a cover member is used to secure designability, and thus the cover member is required for the electric reel. Note that the cover member is subjected to plating treatment for improving appearance, but there have been problems such as difficulty in adhering to the case body and insufficient dimensional accuracy, and the like. In the fishing electric reel 1 according to one embodiment of the present disclosure, in order to solve such problems, the recess-projection fitting portion 20 is provided to allow the switch operating part 16 to be coaxially arranged with the through holes 17 and 18. That is, as a result of providing the cover member, it becomes necessary to devise so that the switch operating part is allowed to be coaxially positioned with the through holes.

The control case 7 for the fishing electric reel 1 of one embodiment of the present disclosure is formed such that one of the cover member 15 or the upper case 14 is provided with an annular projection, while the other of the cover member 15 or the upper case 14 is provided with an annular recess. In this manner, by engaging (fitting) the annular projection with the annular recess such that the through hole 18 of the upper case 14 and the through hole 17 of the cover member 15, through which the switch operating part 16 is inserted, are arranged concentrically with each other, the cover member 15 and the upper case 14 can be accurately and reliably aligned.

In the control case 7 for the fishing electric reel 1 according to one embodiment of the present disclosure, the annular projection described above is provided radially outside the first through hole 17 of the cover member 15 or the second through hole 18 of the upper case 14. Here, the “radially outside” each through hole refers to a position having a larger outer diameter than the diameter of each through hole, and the annular projection is formed to be fitted in such a position. In this manner, coaxial fitting becomes possible.

Furthermore, in the control case 7 for the fishing electric reel 1 according to one embodiment of the present disclosure, the annular recess described above is provided radially outside the first through hole 17 of the cover member 15 or the second through hole 18 of the upper case 14. Here, the “radially outside” each through hole refers to a position having a larger outer diameter than the diameter of each through hole, and the annular recess is formed to be fitted in such a position. In this manner, coaxial fitting becomes possible.

Here, the recess or the projection may each be provided in plural. In this case, a plurality of recesses and a plurality of projections can be fitted with each other. Furthermore, a recess-projection portion as a combination of a recess and a projection and a recess-projection portion as a combination of a projection and a recess may be fitted with each other, or a plurality of recess-projection portions may be fitted with each other as a pair. Furthermore, the recess, the projection, and the recess-projection portion may not each be annular, and various shapes are conceivable. The same applies throughout the present specification.

Dimensions, materials, and arrangements of the components described in the present specification are not limited to those explicitly described in the embodiments, and the components may be modified to have any dimensions, materials, and arrangements that may fall within the scope of the present disclosure. Furthermore, components not explicitly described in the present specification can be added to the described embodiments, or some of the components described in each embodiment can be omitted.

What is claimed is:

1. A control case for a fishing electric reel comprising:
an electrical component;
a case body comprising a lower case and an upper case that has one or a plurality of second through holes;
a cover member having one or a plurality of first through holes;
one or a plurality of switch operating parts; and
a recess-projection fitting portion, wherein
the electrical component is provided for controlling an electric reel,
the case body is arranged on an upper portion of a reel body and houses the electrical component,
the cover member is mounted on an upper side of the upper case,
the one or the plurality of switch operating parts are capable of being operated by pressing and partially exposed from the cover member or partially visible from an outside of the cover member,
the one or the plurality of switch operating parts are capable of being inserted into the one or the plurality of first through holes and the one or the plurality of second through holes, and
the recess-projection fitting portion is configured to align a positioning of the cover member and the upper case in order to ensure concentricity between the first through hole and the second through hole.

2. The control case according to claim 1, further comprising a display part partially exposed from the cover member or partially visible from the outside of the cover member.

3. The control case according to claim 1, wherein one of the cover member or the upper case is provided with an annular projection, while the other of the cover member or the upper case is provided with an annular recess.

4. The control case according to claim 3, wherein the annular projection is provided radially outside the first through hole in the cover member or the second through hole in the upper case.

5. The control case according to claim 3, wherein the annular recess is provided radially outside the first through hole in the cover member or the second through hole in the upper case.

6. A fishing electric reel comprising:
a reel body; and
a control case comprising:
an electrical component;
a case body comprising a lower case and an upper case that has one or a plurality of second through holes;
a cover member having one or a plurality of first through holes;
one or a plurality of switch operating parts; and
a recess-projection fitting portion, wherein
the electrical component is provided for controlling an electric reel,
the case body is arranged on an upper portion of the reel body and houses the electrical component,
the cover member is mounted on an upper side of the upper case,
the one or the plurality of switch operating parts are capable of being operated by pressing and partially exposed from the cover member or partially visible from an outside of the cover member,
the one or the plurality of switch operating parts are capable of being inserted into the one or the plurality of first through holes and the one or the plurality of second through holes, and
the recess-projection fitting portion is configured to align a positioning of the cover member and the upper case in order to ensure concentricity between the first through hole and the second through hole.
